(19) United States
(12) Patent Application Publication
(10) Pub. No.: US 2010/0080871 A1
(43) Pub. Date: Apr. 1, 2010

(54) CAKE KIT

(76) Inventor: Marie L. Doty, Gilbert, AZ (US)

Correspondence Address: LAW OFFICE OF JERRY D. HAYNES , P.A, P.O. Box 350392, Fort Lauderdale, FL, 33335, US

(21) Appl. No.: 12/241,615

(22) Filed: Sep. 30, 2008

(51) Int. Cl. A21D 13/00; A23G 3/50

(52) U.S. Cl. 426/87

(57) ABSTRACT

Disclosed is a cake kit for preparing and decorating a cake. The cake kit includes a cake pan of a predetermined shape, at least one edible decorative item and an instruction means. The cake pan is adapted to enable preparation of a cake therewithin. The at least one edible decorative item is used for decorating the cake. The instruction means provides guidelines for preparing and decorating the cake. In another aspect of the present invention, disclosed is a cake kit. The cake kit includes a cake having a predetermined shape, at least one edible decorative item and an instruction means. The at least one edible decorative item is used for decorating the cake. The instruction means provides guidelines for decorating the cake.

### FIELD OF THE INVENTION

The present invention generally relates to self-help kits, and, more particularly, to a kit for preparing and decorating a cake.

### BACKGROUND OF THE INVENTION

For ages, cake has been a form of food that is widely utilized to celebrate an occasion, such as a birthday, a holiday, New Year, a festive occasion such as Christmas, a sleepover party and the like. Generally, the cake is prepared using at least flour, a sweetening agent such as sugar, a binding agent such as an egg, fat such as butter, and some sort of leavening agent such as yeast and baking powder. The cake is often decorated for enhancing the appearance and the taste of the cake. Further, the cake is decorated based on a theme of the occasion.

However, decoration of the cake in accordance with the theme of an occasion may be time consuming and labor intensive. Specifically, a person decorating the cake may be required to procure various decorative articles from the market for effectively decorating the cake. Specialists such as cake shops and bakeries offer pre-decorated cakes to their customers. However, such cakes are expensive. Moreover, such cakes fail to provide satisfaction to a user since the decoration may not be as per the user's liking. Additionally, such cakes have limited options with regard to the shapes thereof. A person may be forced to buy a cake of a particular shape even if he/she does not like that particular shape.

Accordingly, based on the foregoing, there exists a need for a kit that is capable of facilitating preparation of a cake and decoration thereof by a user as per his/her liking. Further, there is a need for a kit that reduces the cost required for preparing and decorating a cake. Still further, there is a need for a kit, which enables a user to prepare and decorate a cake in an easy and simple manner.

### SUMMARY OF THE INVENTION

In view of the foregoing disadvantages inherent in the prior art, the general purpose of the present invention is to provide a cake kit that is configured to include all the advantages of the prior art, and to overcome the drawbacks inherent therein.

Accordingly, an object of the present invention is to provide a cake kit, which is capable of facilitating preparation of a cake and decoration thereof by a user as per the user's liking.

Another object of the present invention is to provide a cake kit, which is capable of reducing the cost required for preparing and decorating a cake.

Yet another object of the present invention is to provide a cake kit, which enables a user to prepare and decorate a cake in an easy and simple manner.

In light of the above objects, a cake kit for preparing and decorating a cake is disclosed. The cake kit includes a cake pan of a predetermined shape, at least one edible decorative item and an instruction means. The cake pan is adapted to enable preparation of a cake therewithin. The at least one edible decorative item is used for decorating the cake. The instruction means provides guidelines for preparing and decorating the cake.

In another aspect of the present invention, a cake kit is disclosed. The cake kit includes a cake having a predetermined shape, at least one edible decorative item and an instruction means. The at least one edible decorative item is used for decorating the cake. The instruction means provides guidelines for decorating the cake.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1A illustrates a perspective view of a cake kit, in accordance with an embodiment of the present invention;

FIG. 1B illustrates a perspective view of a cake prepared and decorated by the cake kit shown in the FIG. 1A, in accordance with an embodiment of the present invention;

FIG. 2A illustrates a perspective view a cake kit, in accordance with another embodiment of the present invention; and

FIG. 2B illustrates a perspective view of a cake decorated by the cake kit shown in the FIG. 2A, in accordance with another embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular cake kit as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” herein do not denote a limitation of quantity, but rather denote the presence of at least one of the referenced item.

The present invention provides a cake kit for preparing and decorating a cake. The term “cake” as used herein, refers to at least one of a cake, a bread, a pastry, a tart, a quiche and the like.

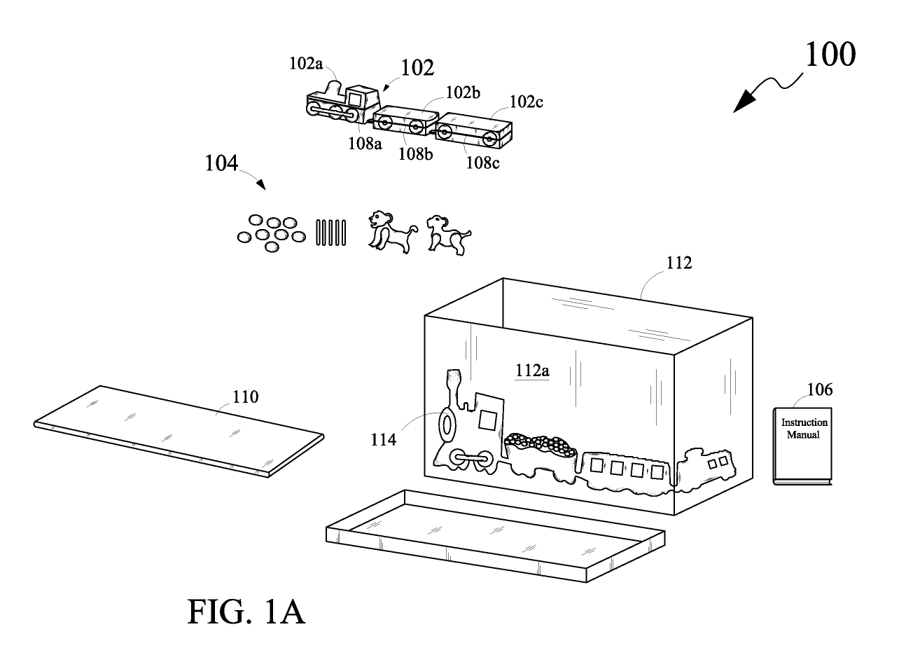

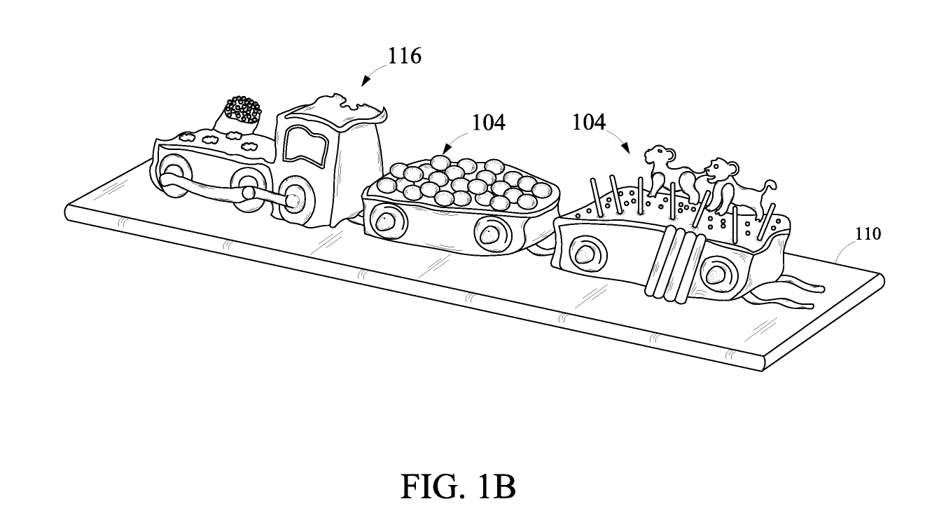

Referring to FIG. 1A, a cake kit 100 for preparing and decorating a cake is illustrated. More specifically, FIG. 1A illustrates a perspective view of the cake kit 100, in accordance with an embodiment of the present invention. Further, FIG. 1B illustrates a perspective view of a cake 116 prepared and decorated by utilizing the cake kit 100. As shown in FIG. 1A, the cake kit 100 includes a cake pan 102, at least one edible decorative item 104 and an instruction means 106.

The cake pan 102 is configured to have a predetermined shape and is capable of enabling a user to prepare the cake 116 therewithin. Specifically, the predetermined shape of the cake pan 102 may be selected from any three dimensional shape as per a user's requirement. The cake pan 102 may be configured to have a shape symbolizing a theme of a festival, a holiday, an event, and the like. Further, the cake pan 102 may be configured to have a shape of a building, a vehicle, a human form, an animal form, a cartoon character and the like. Preferably, the cake pan 102 may be formed by utilizing a molding process. However, it will be evident to a person skilled in the art that the cake pan 102 may also be formed by utilizing other processes known in the art, such as metal forming process. Further, the cake pan 102 is appropriately dimensioned based on a size of the cake 116 to be prepared.

Referring to FIG. 1A, the cake pan 102 is configured to have a shape of a wagon train having a plurality of members such as a locomotive 102a, and a wagon 102b and a wagon 102c. In one embodiment of the present invention, the plurality of members may have a hollow container like construction. Further, each of the plurality of members, such as the locomotive 102a and the wagon 102b and the wagon 102c may includes parting lines such as 108a, 108b and 108c respectively (hereinafter collectively referred to as “parting lines 108”), about which the plurality of members may be opened. After opening of the each of the plurality of members along the parting lines 108, a mixture of cake forming ingredients (not shown) such as flour, a sweetening agent, a binding agent, fats, a liquid and a leavening agent is poured therein. Further, the cake pan 102 is placed in an oven for baking of the cake forming ingredients for preparation of the cake 116. Due to the heat of the oven, the cake forming ingredients set inside the cake pan 102, thereby assuming the shape of the cake pan 102 to form the cake 116 having the shape of the cake pan 102. The shape of the cake pan 102, as described and illustrated herein, is for purpose of explanation only and must not be construed as limiting to the scope of the present invention. Further, the cake 116 may be decorated with the at least one edible decorative item 104.

[Note for the inventor: Due to limited information available in the disclosure regarding the cake pan 102, we have described the cake pan 102 as per our understanding. Please confirm the same. Alternatively, please provide specific details regarding the cake pan 102].

The at least one edible decorative item 104 is used for decorating the cake 116. The at least one edible decorative item 104 includes at least one of an icing composition, a cookie, a candy and the like. The icing composition is a coating of a glossy, generally sweet, substance applied to food items such as a cake. In one embodiment of the present invention the icing composition includes sugar, butter, water, egg whites, milk, added flavors and the like. Further, in one embodiment of the present invention, the at least one edible decorative item 104 may also be configured to have a shape of an animal, a doll, a cartoon character, a castle, a locomotive, a vehicle, a human, a string, a candle and the like. In another embodiment of the present invention, non-edible decorative items such as a candle, a toy and the like may also be used for decorating the cake 116.

Further, the cake 116 may be prepared and decorated with the at least one edible decorative item 104 as per instructions provided in the instruction means 106. Specifically, the instruction means 106 provides guidelines to a user for preparing and decorating the cake 116. The instruction means 106 may include easily comprehendible instructions stored thereon for being understood by users of all ages. In one embodiment of the present invention, the instruction means 106 may include a printed material such as an instruction manual, an instruction sheet and the like. In another embodiment of the present invention, the instruction means 106 may include an electronic storage media having the instructions stored thereon in an electronic form. The electronic storage media may include an audiotape, a videotape, a floppy disk, a compact disk and the like. The electronic storage media stores and retrieves the instructions stored thereon by electronic means. The electronic means includes a computer, a CD player, a DVD player, a tape recorder and the like.

Further, the cake kit 100 may include a board member 110. The board member 110 is configured to support the cake 116 thereon. Specifically, the board member 110 supports the cake pan 102 thereon for preparing the cake 116 therein. In one embodiment of the present invention, the board member 110 is composed of a plastic material. The board member 110 provides a firm support to the cake 116 for enabling the user to prepare and decorate the cake 116 in an easy and simple manner. The board member 110 may be further useful in enabling the cake 116 to be transported once the cake 116 has been prepared and decorated.

Still further, the cake kit 100 further includes an enclosure 112. The enclosure 112 is configured for holding the cake pan 102, the at least one edible decorative item 104, the instruction means 106, the board member 110 and the like therein. The enclosure 112 may be at least one of a box, a case, and the like. The enclosure 112 may include a logo, such as a logo 114, on at least one face, such as a face 112a thereof for enabling the user to identify the contents of the enclosure 112.

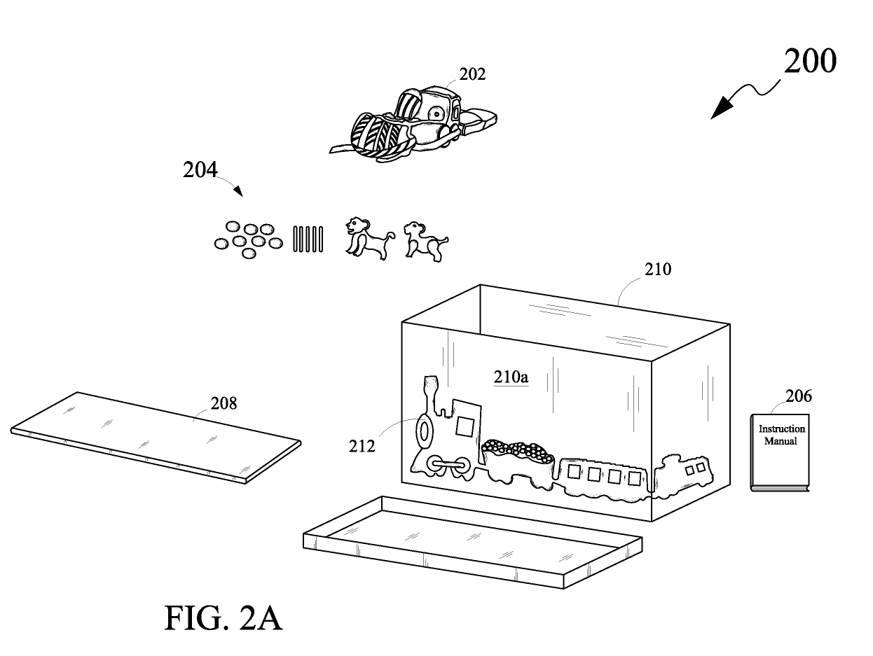

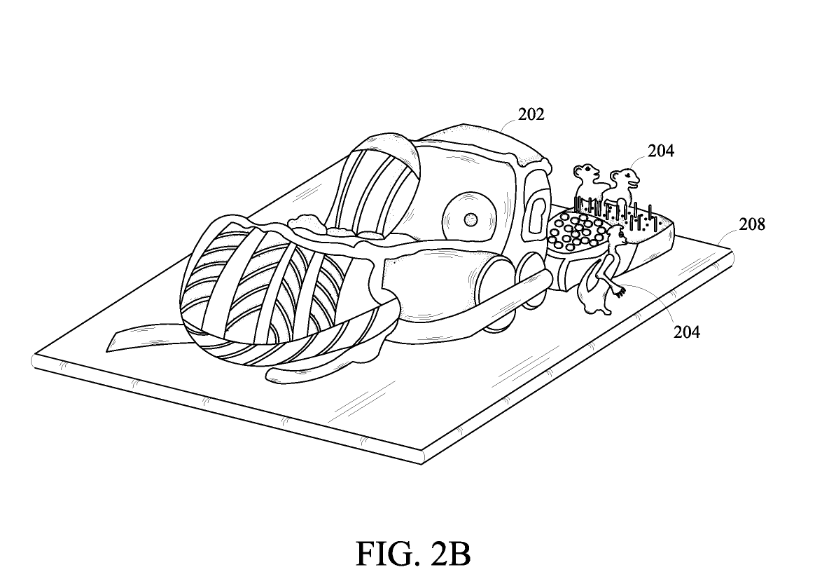

Now referring to FIG. 2A, a cake kit 200 for decorating a cake is illustrated, in accordance with another embodiment of the present invention. The cake kit 200 includes a cake 202, at least one edible decorative item 204 and an instruction means 206.

The cake 202 is configured to have a predetermined shape. Specifically, the cake 202 may be configured to have any three dimensional shape depending on a user's requirement. More specifically, the cake 202 may be configured to have a shape symbolizing a theme of a festival, a holiday, an event, and the like. Further, the cake 202 may be configured to have a shape of a building, a vehicle, a human form, an animal form, a cartoon character and the like. As shown in FIG. 2A, in the present embodiment of the present invention, the cake 202 is configured to have a shape of a wagon train. It will be evident to a person skilled in the art that the shape of the cake 202 as described and illustrated herein is for purpose of explanation only and must not be construed as limiting to the scope of the present invention. Further, in one embodiment of the present invention, the cake 202 may be a frosted cake. The frosted cake may be defrosted before being used.

The cake 202 may be decorated by utilizing the at least one edible decorative item 204. The at least one edible decorative item 204 includes at least one of an icing composition, a cookie, a candy and the like. Further, in one embodiment of the present invention, the at least one edible decorative item 204 may be configured to have a shape of an animal form, a cartoon character, a building, a vehicle, a human form, and the like. In another embodiment of the present invention, non-edible decorative items such as a candle, a toy and the like may also be used for decorating the cake 202. FIG. 2B illustrates a perspective view of the cake 202 decorated by utilizing the at least one edible decorative item 204.

Further, the cake 202 may be decorated as per instructions provided in the instruction means 206. Specifically, the instruction means 206 provides guidelines for decorating the cake 202. In one embodiment of the present invention, the instruction means 206 may include instructions regarding defrosting of the cake 202 and subsequent decoration thereof. The instructions provided in the instruction means 206 may be in an easily comprehendible form for being understood by users of all ages. In one embodiment of the present invention, the instruction means 206 includes a printed material such as an instruction manual, an instruction sheet and the like having written instructions for decorating the cake 202. In another embodiment of the present invention, the instruction means 206 may include an electronic storage media having the instructions stored thereon in an electronic form. The electronic storage media may include an audiotape, a videotape, a floppy disk, a compact disk and the like. The instructions may be stored and retrieved from the electronic storage media by utilizing an electronic means. The electronic means may include a computer, a CD player, a DVD player, a tape recorder and the like.

Further, the cake kit 200 may include a board member 208. The board member 208 is configured to support the cake 202 thereon. In one embodiment of the present invention, the board member 208 is composed of a plastic material. The board member 208 provides a firm support to the cake 202 for enabling a user to easily decorate the cake 202. Further, the board member 208 may be used in transporting the cake 202 comfortably.

Still further, the cake kit 200 may further include an enclosure 210. The enclosure 210 is configured for holding the cake 202, the at least one edible decorative item 204, the instruction means 206, and the board member 208 therein. The enclosure 210 may be at least one of a box, a case and the like. The enclosure 210 may include a logo 212 provided on at least one face 210a thereof for enabling a user to identify the contents of the enclosure 210.

Various embodiments of the present invention offer following advantages. The cake kit, as described herein, is capable of preparing and decorating a cake by a user as per the user's liking. Further, the cake kit is capable of reducing the cost required for preparing and decorating a cake. Furthermore, the cake kit is capable of providing a personalized touch to a cake, thereby providing satisfaction to a user. Moreover, the cake kit facilitates even a small kid to prepare and decorate a cake as per his/her liking.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A cake kit comprising:
a cake pan of a predetermined shape, the cake pan adapted to enable preparation of a cake therewithin;
at least one edible decorative item for decorating the cake; and
an instruction means for providing guidelines for preparing and decorating the cake.

2. The cake kit of claim 1 further comprising a board member configured to support the cake thereon.

3. The cake kit of claim 2, wherein the board member is composed of a plastic material.

4. The cake kit of claim 1, wherein the at least one edible decorative item comprises at least one of an icing composition, a cookie and a candy.

5. The cake kit of claim 1, wherein the predetermined shape of the cake pan comprises at least one of a shape of a building, a vehicle, a human form, an animal form, and a cartoon character.

6. The cake kit of claim 1, wherein the instruction means comprises a printed material.

7. The cake kit of claim 1, wherein the instruction means comprises an electronic storage media having instructions electronically stored thereon.

8. The cake kit of claim 7, wherein the electronic storage media comprises at least one of an audio tape, a videotape, a floppy disk and a compact disk.

9. A cake kit comprising:
a cake having a predetermined shape;
at least one edible decorative item for decorating the cake; and
an instruction means for providing guidelines for decorating the cake.

10. The cake kit of claim 9 further comprising a board member configured to support the cake thereon.

11. The cake kit of claim 10, wherein the board member is composed of a plastic material.

12. The cake kit of claim 9, wherein the at least one edible decorative item comprises at least one of an icing composition, a cookie and a candy.

13. The cake kit of claim 9, wherein the instruction means comprises a printed material.

14. The cake kit of claim 9, wherein the instruction means comprises an electronic storage media having instructions electronically stored thereon.

15. The cake kit of claim 14, wherein the electronic storage media comprises at least one of an audio tape, a videotape, a floppy disk and a compact disk.

16. The cake kit of claim 9, wherein the predetermined shape of the cake comprises at least one of a shape of a building, a vehicle, a human form, an animal form, and a cartoon character.

17. The cake kit of claim 9, wherein the cake is a frosted cake.
